(19) United States
(12) Patent Application Publication
(10) Pub. No.: US 2026/0245344 A1
(43) Pub. Date: Aug. 20, 2026

(54) VIDEO PROCESSING DEVICE, VIDEO PROCESSING METHOD, AND RECORDING MEDIUM

(71) Applicant: NEC Corporation, Tokyo (JP)

(72) Inventor: Shuhei YOSHIDA, Tokyo (JP)

(73) Assignee: NEC Corporation, Tokyo (JP)

(21) Appl. No.: 19/159,873

(22) PCT Filed: Mar. 3, 2023
(86) PCT No.: PCT/JP2023/008113

§ 371 Date: Aug. 26, 2025

(51) Int. Cl. G06V 10/77; G06V 10/82

(52) U.S. Cl. CPC G06V 10/7715; G06V 10/82; G06V 2201/07

(57) ABSTRACT

In a video processing device, a video acquisition means acquires video. A plurality of conversion means, which is sequentially arranged, converts an input feature map of the video, and outputs a converted feature map. An identification element extraction means detects an identification element from the video, and outputs an identification element feature. An identification element reference conversion means is arranged between the plurality of conversion means, and generates and outputs a converted feature map and a converted identification element feature based on the input feature map and the identification element feature.

### TECHNICAL FIELD

The present disclosure relates to feature extraction from video.

### BACKGROUND ART

In video recognition technology using a neural network (NN), a method of introducing a non-local layer in an intermediate layer (non-local neural networks) has been proposed to improve accuracy (see Non-Patent Literature 1). Patent Document 1 proposes a feature conversion device and an image recognition device in which a technology related to the above-described method of introducing a non-local layer in an intermediate layer is improved.

### PRECEDING TECHNICAL REFERENCE

### Patent Document

Patent Document 1: WO 2021/176566 A1

### Non-Patent Literature

Non-Patent Literature 1: Non-Local Neural Networks, Xiaolong Wang, Ross Girshick, Abhinav Gupta, Kaiming He Proceedings of the IEEE Conference on Computer Vision and Pattern Recognition (CVPR), 2018, pp. 7794-7803

### SUMMARY

### Problem to be Solved

In the video recognition using an NN, it is required to perform feature conversion, extract an identification element included in video, and perform recognition based on the extracted identification element. As described above, since the identification element is used only in the downstream recognition task according to the video recognition using the NN, the feature conversion may not have been optimally performed based on the identification element. Also in the method of Non-Patent Literature 1, since the non-local layer does not explicitly encode the identification element, optimal feature conversion has not been achieved.

An example object of the present disclosure is to provide a video processing device capable of performing optimal feature conversion by using a feature of an identification element.

### Means for Solving the Problem

According to an example aspect of the present invention, there is provided a video processing device, including:
a video acquisition means for acquiring video;
a plurality of conversion means for converting an input feature map of the video and outputting a converted feature map, the plurality of conversion means being sequentially arranged;

an identification element extraction means for detecting an identification element from the video and outputting an identification element feature; and

an identification element reference conversion means for generating and outputting a converted feature map and a converted identification element feature based on an input feature map and the identification element feature, the identification element reference conversion means being arranged between the plurality of conversion means.

According to another example aspect of the present invention, there is provided a video processing method including:
acquiring video;
converting an input feature map of the video and outputting a converted feature map;
detecting an identification element from the video and outputting an identification element feature; and
generating and outputting a feature map and an identification element feature based on the converted feature map and the identification element feature.

According to a further example aspect of the present invention, there is provided a recording medium recording a program for causing a computer to execute processing including:
acquiring video;
converting an input feature map of the video and outputting a converted feature map;
detecting an identification element from the video and outputting an identification element feature; and
generating and outputting a feature map and an identification element feature based on the converted feature map and the identification element feature.

### Effect

According to the present disclosure, optimal feature conversion may be performed by using a feature of an identification element.

### BRIEF DESCRIPTION OF THE DRAWINGS

FIG. 1 is a block diagram illustrating a schematic configuration of a video processing device according to a first example embodiment.

FIG. 2 is a block diagram illustrating a hardware configuration of a feature conversion device.

FIG. 3 is a block diagram illustrating a functional configuration of the feature conversion device.

FIG. 4 is a block diagram illustrating a functional configuration of an identification element reference non-local layer.

FIG. 5 is a block diagram illustrating a configuration of an identification element reference non-local layer according to a first modified example.

FIG. 6 is a block diagram illustrating another configuration of the identification element reference non-local layer according to the first modified example.

FIG. 7 is a block diagram illustrating a functional configuration of a feature conversion device according to a second modified example.

FIG. 8 is a block diagram illustrating a functional configuration of a video processing device according to a second example embodiment.

FIG. 9 is a flowchart of a process to be performed by the video processing device according to the second example embodiment.

### EXAMPLE EMBODIMENTS

Hereinafter, preferred example embodiments of the present disclosure will be described with reference to the drawings.

### First Example Embodiment

### [System Configuration]

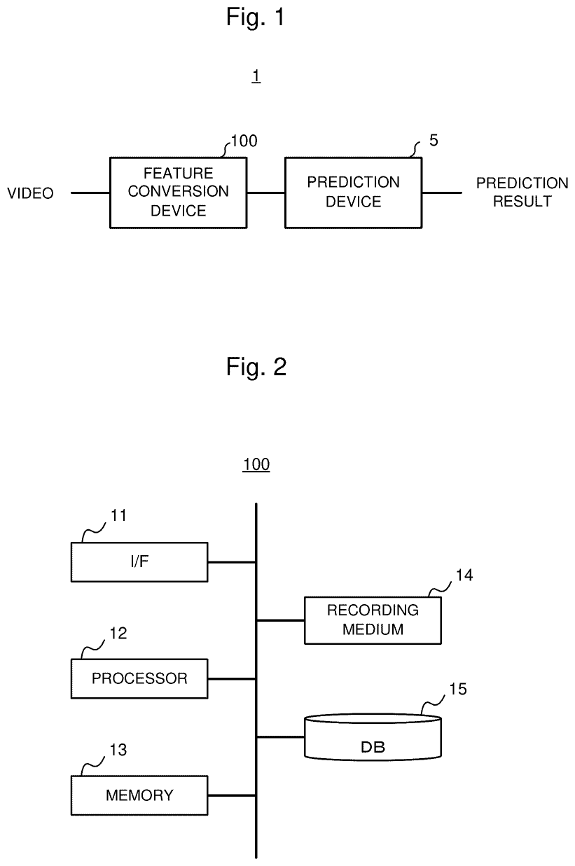

FIG. 1 illustrates a schematic configuration of a video processing device 1. The video processing device 1 includes a feature conversion device 100 and a prediction device 5. The feature conversion device 100 generates a feature map from input video, and outputs it to the prediction device 5. The prediction device 5 recognizes an object included in the video based on the feature map input from the feature conversion device 100, and outputs a result.

The feature conversion device 100 according to the present example embodiment is characterized in that the feature map is generated using an identification element. The identification element is an element required to identify the object, and is an element having information required to execute a task to be performed downstream of the feature conversion device 100, that is, prediction to be performed by the prediction device 5 in the present example embodiment. For example, in a case of human behavior recognition, a target person included in the video, an object related to the behavior of the target person, or the like serves as an identification element. The feature conversion device 100 detects the identification element from the input video, and extracts a feature of the identification element. Then, the feature conversion device 100 generates a feature map using the feature of the identification element, and outputs it to the prediction device 5.

### [Hardware Configuration]

FIG. 2 is a block diagram illustrating a hardware configuration of the feature conversion device 100 according to a first example embodiment. As illustrated, the feature conversion device 100 includes an interface (I/F) 11, a processor 12, a memory 13, a recording medium 14, and a database (DB) 15.

The I/F 11 exchanges data with an external device. Specifically, the I/F 11 receives input data when video to be used by the feature conversion device 100 is input by external communication. The I/F 11 is also used when the feature map generated by the feature conversion device 100 is output to the external device.

The processor 12 is a computer such as a central processing unit (CPU), and takes overall control of the feature conversion device 100 by executing a program prepared in advance. The processor 12 may be a graphics processing unit (GPU) or a field-programmable gate array (FPGA).

The memory 13 includes a read only memory (ROM), a random access memory (RAM), and the like. The memory 13 is also used as a working memory during execution of various types of processing by the processor 12.

The recording medium 14 is a non-volatile non-transitory recording medium, such as a disk-shaped recording medium, a semiconductor memory, or the like, and is detachable from the feature conversion device 100. The recording medium 14 records various programs to be executed by the processor 12. When the feature conversion device 100 executes various types of processing, a program recorded in the recording medium 14 is loaded into the memory 13, and is executed by the processor 12.

The DB 15 stores data exchanged through the I/F 11 as appropriate.

### [Functional Configuration]

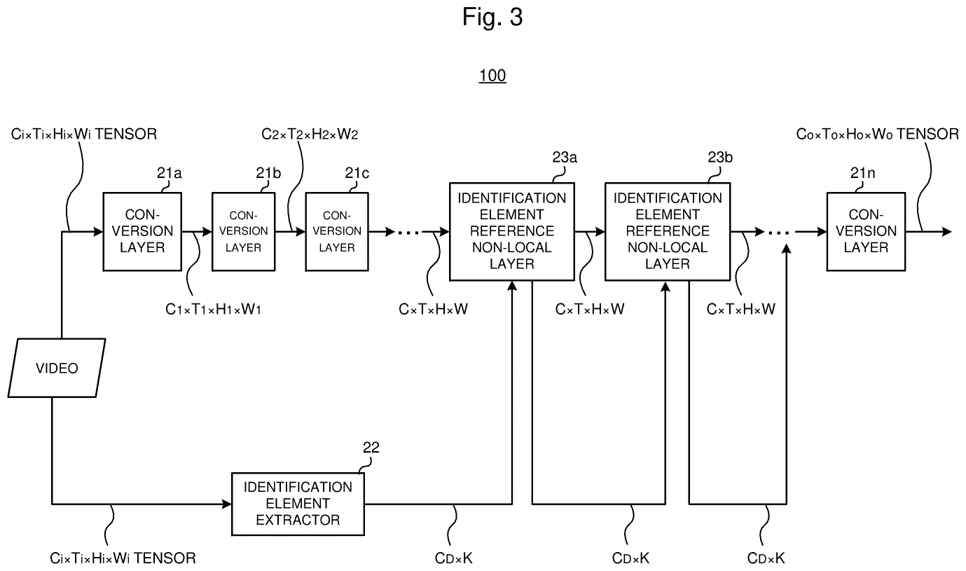

FIG. 3 is a block diagram illustrating a functional configuration of the feature conversion device 100 according to the first example embodiment. The feature conversion device 100 functionally includes conversion layers 21a to 21n, an identification element extractor 22, and identification element reference non-local layers 23a and 23b. In the following descriptions, the individual conversion layers 21a to 21n may be simply referred to as a “conversion layer 21” unless otherwise distinguished. The individual identification element reference non-local layers 23a and 23b may be simply referred to as an “identification element reference non-local layer 23” unless otherwise distinguished. While FIG. 3 illustrates two identification element reference non-local layers of the identification element reference non-local layers 23a and 23b for convenience of illustration, a plurality of identification element reference non-local layers is also assumed to be provided at a subsequent stage of the identification element reference non-local layer 23b.

The feature conversion device 100 receives video from an external device through the I/F 11. The video is input to the conversion layer 21a and to the identification element extractor 22. The video is a tensor of Cᵢ×Tᵢ×Hᵢ×Wᵢ. “Cᵢ” represents the number of channels, and “Cᵢ” is 3 when the input video includes three channels of RGB. “Tᵢ” represents a time, “H;” represents an image height (number of vertical pixels), and “Wᵢ” represents an image width (number of horizontal pixels).

For example, the conversion layer 21 includes a convolution layer, a residual block layer, a pooling layer, and the like, and converts the input feature map to output a converted feature map. Specifically, the conversion layers 21a to 21n are sequentially arranged, and the conversion layer 21a performs processing, such as convolution, on the input video, and outputs the generated feature map to the conversion layer 21b at a subsequent stage. The conversion layer 21b performs processing, such as convolution, on the input feature map, and outputs the generated feature map to the conversion layer 21c at a subsequent stage. Then, the feature map generated through the processing in each conversion layer is output to the prediction device 5.

The identification element extractor 22 detects an identification element from the input video, and extracts a feature thereof (which will also be referred to as a “identification element feature” hereinafter). One type of identification element is set in advance in the identification element extractor 22. In a case where K identification elements corresponding to the one type are detected from the input video, the identification element extractor 22 extracts identification element features (C_{D}×K), which are C_{D}-dimensional vector values corresponding to the identification elements. The C_{D} dimension is a predetermined number of dimensions determined in advance. For example, in a case where a cart is set as an identification element and the input video includes three carts, the identification element extractor 22 extracts the identification element features (C_{D}×3) of the carts. Then, the identification element extractor 22 outputs the extracted identification element features to the identification element reference non-local layer 23a.

For example, in a case where the identification element is a person, the identification element extractor 22 outputs, as identification element features, information such as coordinates, a size, coordinates of joint points, appearance-related feature values, and the like of the person. In a case where the identification element is an object, the identification element extractor 22 extracts, as identification element features, information such as coordinates, a size, a type, pose information, appearance-related feature values, and the like of the object. In a case where the identification element is interaction between a person and an object, the identification element extractor 22 extracts, as identification element features, coordinates of the interacting elements (i.e., person and object), types of the elements, types of interaction, and the like.

The identification element reference non-local layer 23a is arranged at one of the positions between the conversion layers 21a to 21n. The identification element reference non-local layer 23a generates a feature map and an identification element feature based on the feature map input from the conversion layer 21 of a preceding stage and the identification element feature input from the identification element extractor 22, respectively. The identification element reference non-local layer 23a outputs the generated feature map and the generated identification element feature to the identification element reference non-local layer 23b at a subsequent stage. The identification element reference non-local layer 23b is arranged at a subsequent stage of the identification element reference non-local layer 23a. The identification element reference non-local layer 23b generates a feature map and an identification element feature based on the feature map and the identification element feature input from the identification element reference non-local layer 23a at the preceding stage, respectively. The identification element reference non-local layer 23b outputs the generated feature map to the conversion layer 21 at a subsequent stage. The identification element reference non-local layer 23b further outputs the generated identification element feature to the identification element reference non-local layer 23 at a subsequent stage.

While the identification element reference non-local layers 23a and 23b are sequentially arranged in FIG. 3, a plurality of conversion layers 21 may be arranged between the identification element reference non-local layer 23a and the identification element reference non-local layer 23b. In that case, the identification element reference non-local layer 23a outputs the generated feature map to the conversion layer 21 at a subsequent stage, and outputs the generated identification element feature to the identification element reference non-local layer 23b.

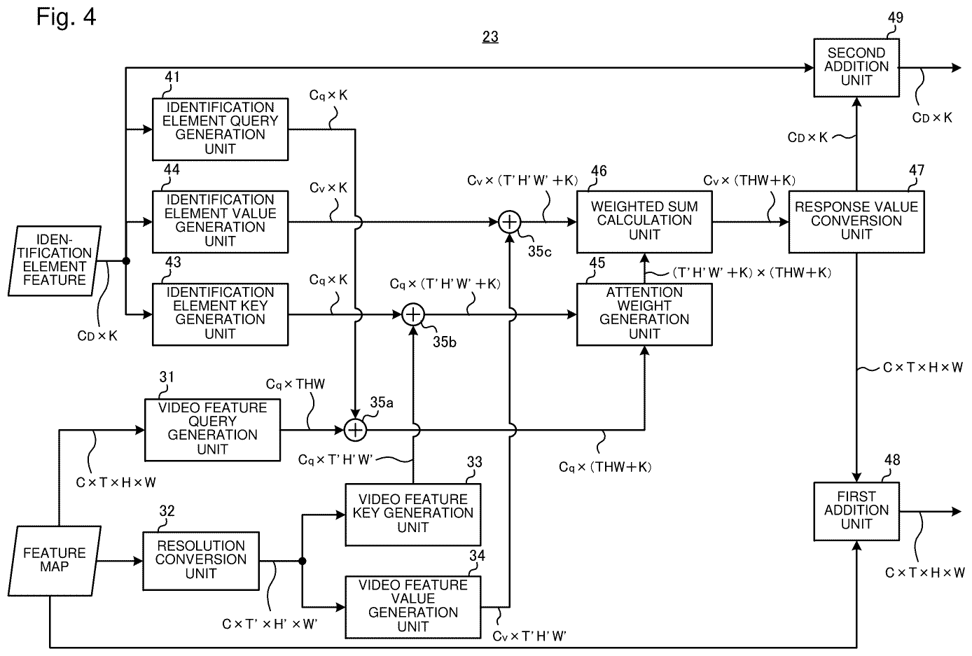

FIG. 4 illustrates a configuration of the identification element reference non-local layer 23. The identification element reference non-local layer 23 includes a video feature query generation unit 31, a resolution conversion unit 32, a video feature key generation unit 33, a video feature value generation unit 34, concatenation units 35a, 35b, and 35c, an identification element query generation unit 41, an identification element key generation unit 43, an identification element value generation unit 44, an attention weight generation unit 45, a weighted sum calculation unit 46, a response value conversion unit 47, a first addition unit 48, and a second addition unit 49.

The identification element reference non-local layer 23 includes a kind of attention device with four attention mechanisms. The attention device refers to a device that outputs a response feature with a query element, key element, and value element as inputs. More specifically, the attention device refers to a device comprising a mechanism that, for each query generated from a query element, controls a value (generated from a value element) to be incorporated based on similarity between the query and a key generated from a key element.

The identification element reference non-local layer 23 in FIG. 4 includes four attention mechanisms of self-attention in which the query element is video and each of the key element and the value element is video, cross-attention in which the query element is video and each of the key element and the value element is an identification element, cross-attention in which the query element is an identification element and each of the key element and the value element is video, and self-attention in which the query element is an identification element and each of the key element and the value element is an identification element.

The identification element reference non-local layer 23 receives the feature map from the conversion layer 21. The feature map is a tensor of a type of C×T×H×W. The identification element reference non-local layer 23 further receives the K identification element features (C_{D}×K) from the identification element extractor 22 or from the identification element reference non-local layer 23 at a preceding stage.

The video feature query generation unit 31 receives the feature map from the conversion layer 21. The video feature query generation unit 31 generates queries using the input feature map (C×T×H×W) as query elements. Specifically, the video feature query generation unit 31 performs dimension conversion to convert C-dimensional vectors of individual points of the feature map into C_{q}-dimensional queries (C_{q}×THW). This dimension conversion may be carried out by, for example, linear conversion or a combination of linear conversion, an activation function, and layer normalization. The C_{q} dimension is a predetermined number of dimensions determined in advance. The video feature query generation unit 31 converts the queries in such a way that the number of dimensions of the queries matches the number of dimensions of keys to be described later. Since there are THW points in the feature map, the number of queries is THW. The video feature query generation unit 31 outputs the generated video feature queries to the concatenation unit 35a.

The resolution conversion unit 32 receives the feature map from the conversion layer 21. The resolution conversion unit 32 converts the resolution of the input feature map into a predetermined value. The resolution conversion unit 32 outputs the resolution-converted feature map (C×T′×H′×W′) to the video feature key generation unit 33 and to the video feature value generation unit 34.

The video feature key generation unit 33 generates keys using the feature map (C×T′×H′×W′) input from the resolution conversion unit 32 as key elements. Specifically, the video feature key generation unit 33 converts the C-dimensional vectors of individual points of the feature map into C_{q}-dimensional keys (C_{q}×T′H′W′). This dimension conversion may be carried out by, for example, linear conversion or a combination of linear conversion, an activation function, and layer normalization. Since there are T′H′W′ points in the feature map, the number of keys is T′H′W′. The video feature key generation unit 33 outputs the generated video feature keys to the concatenation unit 35b.

The video feature value generation unit 34 generates values using the feature map (C×T′×H′×W′) input from the resolution conversion unit 32 as value elements. Specifically, the video feature value generation unit 34 converts the C-dimensional vectors of individual points of the feature map into Cᵥ-dimensional values (Cᵥ×T′H′W′). This dimension conversion may be carried out by, for example, linear conversion or a combination of linear conversion, an activation function, and layer normalization. The Cᵥ dimension is a predetermined number of dimensions determined in advance. Since there are T′H′W′ points in the feature map, the number of values is T′H′W′. The video feature value generation unit 34 outputs the generated video feature values to the concatenation unit 35c.

The resolution conversion unit 32 may be omitted. In that case, the video feature key generation unit 33 and the video feature value generation unit 34 only need to generate keys and values from the feature map (C×T×H×W) input from the conversion layer 21.

The identification element query generation unit 41 receives the K identification element features from the identification element extractor 22 or from the identification element reference non-local layer 23 at a preceding stage. The identification element query generation unit 41 generates queries using the input identification element features (C_{D}×K) as query elements. Specifically, the identification element query generation unit 41 converts the C_{D}-dimensional identification element features (C_{D}×K) into C_{q}-dimensional queries (C_{q}×K) same as the queries generated by the video feature query generation unit 31. This dimension conversion may be carried out by, for example, linear conversion or a combination of linear conversion, an activation function, and layer normalization. The identification element query generation unit 41 outputs the generated identification element queries to the concatenation unit 35a.

The identification element key generation unit 43 receives the K identification element features from the identification element extractor 22 or from the identification element reference non-local layer 23 at the preceding stage. The identification element key generation unit 43 generates identification element keys using the input identification element features as key elements. Specifically, the identification element key generation unit 43 converts the C_{D}-dimensional identification element features (C_{D}×K) into C_{q}-dimensional identification element keys (C_{q}×K) same as the keys generated by the video feature key generation unit 33. This dimension conversion may be carried out by, for example, linear conversion or a combination of linear conversion, an activation function, and layer normalization. The identification element key generation unit 43 outputs the generated identification element keys to the concatenation unit 35b.

The identification element value generation unit 44 receives the K identification element features from the identification element extractor 22 or from the identification element reference non-local layer 23 at the preceding stage. The identification element value generation unit 44 generates identification element values using the input identification element features as value elements. Specifically, the identification element value generation unit 44 converts the C_{D}-dimensional identification element features (C_{D}×K) into Cᵥ-dimensional identification element values (Cᵥ×K) same as the values generated by the video feature value generation unit 34. This dimension conversion may be carried out by, for example, linear conversion or a combination of linear conversion, an activation function, and layer normalization. The identification element value generation unit 44 outputs the generated identification element values to the concatenation unit 35c.

The concatenation unit 35a receives the video feature queries (C_{q}×THW) from the video feature query generation unit 31, and receives the identification element queries (C_{q}×K) from the identification element query generation unit 41. The concatenation unit 35a concatenates a C_{q}×THW matrix in which the THW video feature queries are arranged and a C_{q}×K matrix in which the K identification element queries are arranged. The concatenation unit 35a outputs the concatenated queries (C_{q}×(THW+K)) to the attention weight generation unit 45.

The concatenation unit 35b receives the video feature keys (C_{q}×T′H′W′) from the video feature key generation unit 33, and receives the identification element keys (C_{q}×K) from the identification element key generation unit 43. The concatenation unit 35b concatenates a C_{q}×T′H′W′ matrix in which the T′H′W′ video feature keys are arranged and a C_{q}×K matrix in which the K identification element keys are arranged. The concatenation unit 35b outputs the concatenated keys (C_{q}×(T′H′W′+K)) to the attention weight generation unit 45.

The concatenation unit 35c receives the video feature values (Cᵥ×T′H′W′) from the video feature value generation unit 34, and receives the identification element values (Cᵥ×K) from the identification element value generation unit 44. The concatenation unit 35c concatenates a Cᵥ×T′H′W′ matrix in which the T′H′W′ video feature values are arranged and a Cᵥ×K matrix in which the K identification element values are arranged. The concatenation unit 35c outputs the concatenated values (Cᵥ×(T′H′W′+K)) to the weighted sum calculation unit 46.

The attention weight generation unit 45 receives the concatenated queries (C_{q}×(THW+K)) from the concatenation unit 35a, and receives the concatenated keys (C_{q}×(T′H′W′+K)) from the concatenation unit 35b. The attention weight generation unit 45 generates a weight for each value based on the similarity between a query and a key corresponding thereto.

Specifically, the attention weight generation unit 45 generates a weight using an inner product of the query and the key. As an example, when a C_{q}×(THW+K) matrix in which the THW+K queries are arranged is represented by “Q”, a C_{q}×(T′H′W′+K) matrix in which the T′H′W′+K keys are arranged is represented by “K”, and a weight matrix of (THW+K)×(T′H′W′+K) as an output is represented by “A”, the weight matrix A is expressed by the following formula.

$$A = ( {Q}^{T} K ) / ( {T}^{′} {H}^{′} {W}^{′} ) \qquad [ Math . 1 ]$$

As another example, the attention weight generation unit 45 calculates an inner product of the query and the key, and generates a weight by performing normalization using a SoftMax function. In that case, the weight matrix A is expressed by the following formula.

$${A}_{ij} = exp ( \frac{{( {Q}^{T} K )}_{ij}}{\sqrt{{C}_{q}}} ) / ( {Σ}_{k} exp ( \frac{{( {Q}^{T} K )}_{ik}}{\sqrt{{C}_{q}}} ) ) \qquad [ Math . 2 ]$$

Then, the attention weight generation unit 45 outputs the generated weights to the weighted sum calculation unit 46.

The weighted sum calculation unit 46 receives the concatenated values (Cᵥ×(T′H′W′+K)) from the concatenation unit 35c, and receives the weights from the attention weight generation unit 45. The weighted sum calculation unit 46 generates response values based on the values and the weights. For example, the weighted sum calculation unit 46 calculates a weighted sum of the values by performing matrix products of the values (Cᵥ×(T′H′W′+K)) and the weights (THW+K)× (T′H′W′+K), and generates response values (Cᵥ×(THW+K)). The weighted sum calculation unit 46 outputs the generated response values to the response value conversion unit 47.

The response value conversion unit 47 decomposes the response values input from the weighted sum calculation unit 46 into response values for the feature map and response values for the identification element feature. Specifically, the response value conversion unit 47 decomposes the response values Cᵥ×(THW+K) into a Cᵥ×THW matrix, which represents response values for the feature map, and a Cᵥ×K matrix, which represents response values for the identification element feature.

Then, the response value conversion unit 47 converts the Cᵥ×THW matrix into C-dimensional vectors (C×THW) same as the feature map input from the conversion layer 21. The response value conversion unit 47 outputs the converted response values (which will also be referred to as a “feature map residual” or a “first feature map” hereinafter) to the first addition unit 48. The response value conversion unit 47 converts the Cᵥ×K matrix into C_{D}-dimensional vectors (C_{D}×K) same as the identification element features input from the identification element extractor 22 or from the identification element reference non-local layer 23 at a preceding stage. Then, the response value conversion unit 47 outputs the converted response values (which will also be referred to as a “identification element feature residual” or a “second feature map” hereinafter) to the second addition unit 49.

The first addition unit 48 receives the feature map from the conversion layer 21, and receives the feature map residual from the response value conversion unit 47. The first addition unit 48 calculates a sum of the input feature map and feature map residual. The first addition unit 48 outputs a calculation result (which will also be referred to as a “converted feature map” hereinafter) to the conversion layer or the identification element reference non-local layer arranged at a subsequent stage of the identification element reference non-local layer 23.

The second addition unit 49 receives the identification element features from the identification element extractor 22 or from the identification element reference non-local layer 23 at a preceding stage, and receives the identification element feature residual from the response value conversion unit 47. The second addition unit 49 calculates a sum of the identification element features and the identification element feature residual. The second addition unit 49 outputs a calculation result (which will also be referred to as “converted identification element features” hereinafter) to the identification element reference non-local layer arranged at the subsequent stage of the identification element reference non-local layer 23.

Returning to FIG. 3, the converted feature map output from the identification element reference non-local layer 23 is input to the identification element reference non-local layer or the conversion layer 21 of a subsequent stage. The converted identification element features output from the identification element reference non-local layer 23 are input to the identification element reference non-local layer of the subsequent stage. Then, the feature map finally generated through sequential processing in each layer is output to the prediction device 5.

As described above, according to the present example embodiment, the identification element reference non-local layer 23 generates the feature map using the identification elements, whereby an optimal feature map may be output for a downstream task. Moreover, according to the present example embodiment, each of the identification element reference non-local layers 23 generates a converted identification element feature, and the identification element reference non-local layer 23 at a subsequent stage uses the converted identification element feature as an identification element feature, whereby the identification element reference non-local layer 23 at the subsequent stage is enabled to generate a feature map using the optimal identification element feature.

In the configuration described above, the conversion layer 21 is an example of a video acquisition means and a conversion means, the identification element extractor 22 is an example of the video acquisition means and an identification element extraction means, and the identification element reference non-local layer 23 is an example of an identification element reference conversion means.

### Modifications

Next, modifications of the first example embodiment will be described. The following modifications may be appropriately combined and applied to the first example embodiment.

### (Modification 1)

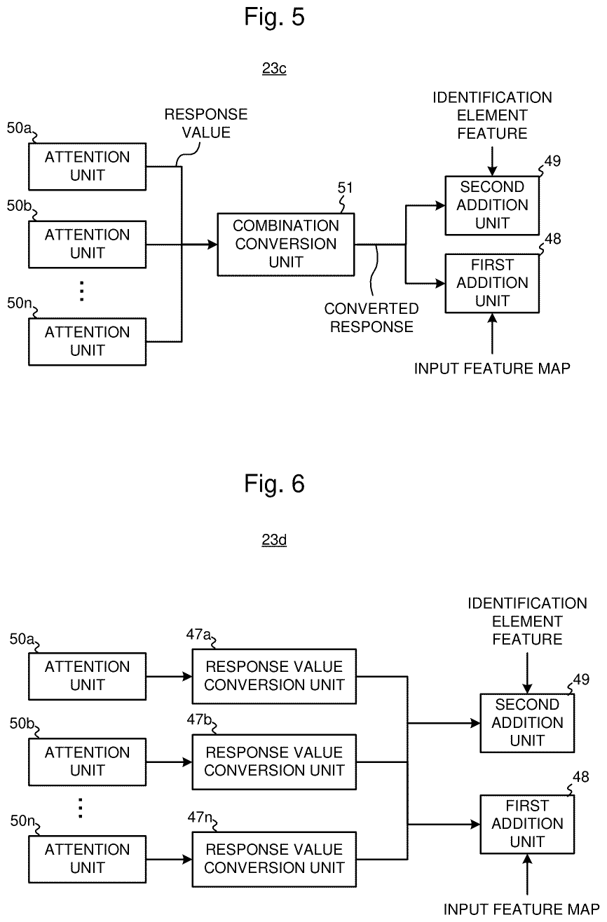

In the feature conversion device 100 described above, for example, the identification element extractor 22 extracts one type of identification element such as a person. However, the feature conversion device 100 may also perform feature conversion using a plurality of types of identification elements. The plurality of types of identification elements indicates identification elements having different dimensions and number of identification element features. Examples of a use of the plurality of types of identification elements include a use of a person feature and an object feature in combination, and a use of person and object features and interaction features between a person and an object in combination. In that case, the identification element reference non-local layer 23 is provided with attention units 50 in parallel for each identification element type. FIGS. 5 and 6 illustrate an exemplary configuration of the identification element reference non-local layer 23 when the plurality of attention units 50 is provided. It is assumed that the attention unit 50 includes the video feature query generation unit 31, the resolution conversion unit 32, the video feature key generation unit 33, the video feature value generation unit 34, the concatenation units 35a, 35b, and 35c, the identification element query generation unit 41, the identification element key generation unit 43, the identification element value generation unit 44, the attention weight generation unit 45, and the weighted sum calculation unit 46.

FIG. 5 illustrates a first example of an identification element reference non-local layer according to a modification 1. In the first example, an identification element reference non-local layer 23c includes a plurality of attention units (attention mechanisms) 50a to 50n, and a concatenation conversion unit 51. The plurality of attention units 50a to 50n is corresponding to identification elements of different types. For example, when a person feature, an object feature, and an interaction feature between a person and an object are used as a plurality of types of identification elements, the attention unit 50a includes an attention mechanism for the person feature, the attention unit 50b includes an attention mechanism for the object feature, and the attention unit 50c includes an attention mechanism for the interaction feature between the person and the object.

The combination conversion unit 51 receives the individual response values generated by the attention units 50a to 50n. The concatenation conversion unit 51 concatenates the individual response values, and converts the concatenated response values into a feature map residual and an identification element feature residual. The concatenation conversion unit 51 outputs the feature map residual to the first addition unit 48, and outputs the identification element feature residual to the second addition unit 49. The first addition unit 48 adds the feature map residual to the input feature map, and outputs the added feature map to the conversion layer 21 of a subsequent stage. The second addition unit 49 adds the identification element feature residual to the identification element features, and outputs the added identification element features to the identification element reference non-local layer 23 of a subsequent stage.

FIG. 6 illustrates a second example of the identification element reference non-local layer according to the modification 1. In the second example, the identification element reference non-local layer 23d includes the plurality of attention units 50a to 50n, and a plurality of response value conversion units 47a to 47n. That is, in the example of FIG. 6, the response value conversion units 47a to 47n are provided in association with the attention units 50a to 50n, respectively. Each of the response value conversion units 47a to 47n converts the response values input from the attention units 50a to 50n into a feature map residual and an identification element feature residual. Then, the response value conversion units 47a to 47n each output the feature map residual to the first addition unit 48, and each output the identification element feature residual to the second addition unit 49. The first addition unit 48 adds each feature map residual to the input feature map, and outputs the added feature map to the conversion layer 21 of a subsequent stage. The second addition unit 49 adds each identification element feature residual to the identification element features, and outputs the added identification element features to the identification element reference non-local layer 23 of a subsequent stage.

The first example of the identification element reference non-local layer illustrated in FIG. 5 and the second example of the identification element reference non-local layer illustrated in FIG. 6 may be combined. That is, the outputs of some of the plurality of attention units 50 may be input to the first addition unit 48 and the second addition unit 49 via the concatenation conversion unit, and the outputs of other attention units 50 may be input to the first addition unit 48 and the second addition unit 49 via the individually provided response value conversion units 47.

### (Modification 2)

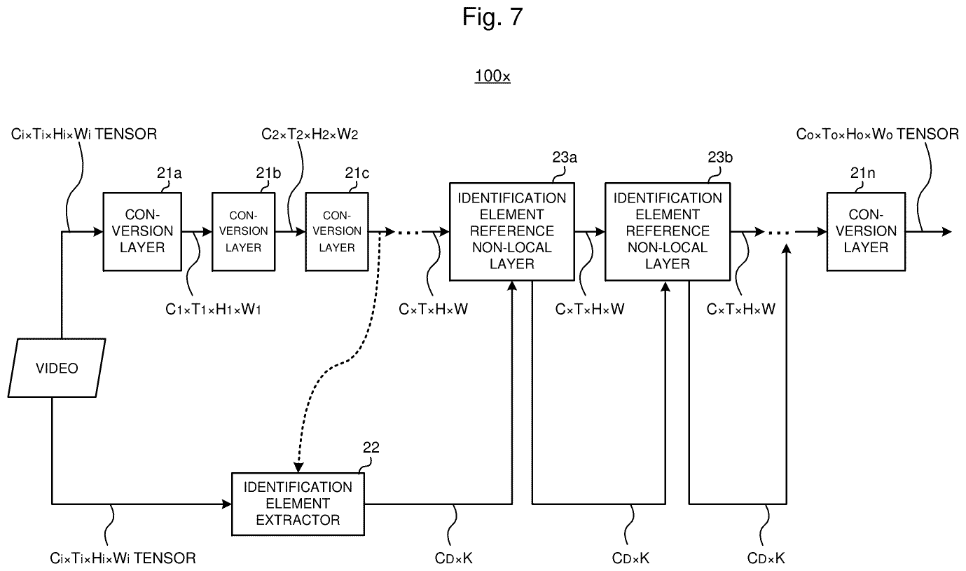

In the first example embodiment described above, the identification element extractor 22 extracts the identification element features based on the video input from the external device. Instead, the identification element extractor 22 may extract the identification element features using the video input from the external device and the feature map output from any of the conversion layers located at a preceding stage of the identification element reference non-local layer 23. FIG. 7 illustrates a configuration of a feature conversion device 100x according to a modification 2. In the example of FIG. 7, the identification element extractor 22 extracts the identification element features based on the video input from the external device and the feature map input from the conversion layer 21c. For example, the identification element extractor 22 detects an identification element such as an object from the video, and extracts, from the feature map, a feature of a region corresponding to the identification element. That is, the identification element extractor 22 detects the position of the target identification element in the image based on the input video, and extracts, as an identification element feature, the feature of the region corresponding to the position thereof in the input feature map. Then, the identification element extractor 22 outputs the extracted features to the identification element reference non-local layer 23 as the identification element features.

### Second Example Embodiment

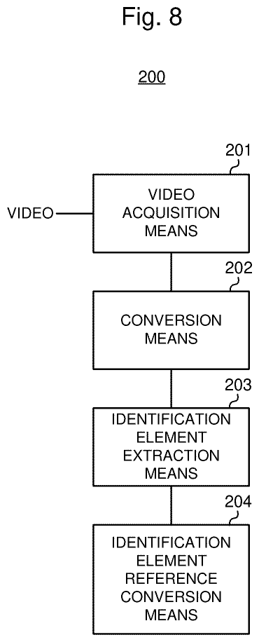

FIG. 8 is a block diagram illustrating a functional configuration of a video processing device according to a second example embodiment. A video processing device 200 includes a video acquisition means 201, a plurality of conversion means 202, an identification element extraction means 203, and an identification element reference conversion means 204.

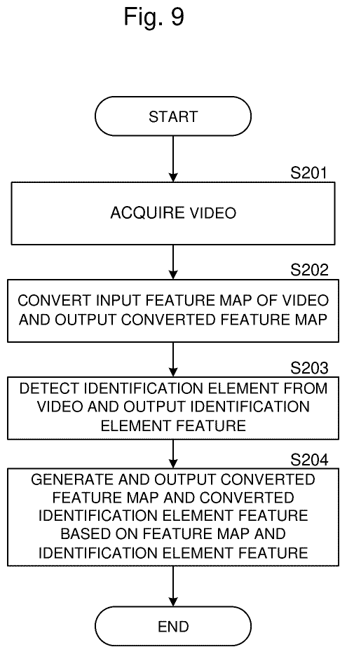

FIG. 9 is a flowchart of a process to be performed by the video processing device according to the second example embodiment. The video acquisition means 201 acquires video (step S201). The plurality of conversion means 202, which is sequentially arranged, converts an input feature map of the video, and outputs a converted feature map (step S202). The identification element extraction means 203 detects an identification element from the video, and outputs an identification element feature (step S203). The identification element reference conversion means 204 is arranged between the plurality of conversion means, and generates and outputs a converted feature map and a converted identification element feature based on the input feature map and the identification element feature (step S204).

According to the video processing device 200 according to the second example embodiment, optimal feature conversion may be carried out by using the features of the identification elements.

Some or all of the example embodiments described above may also be described as the following Supplementary Notes, but are not limited to the following.

### (Supplementary Note 1)

A video processing device comprising:
a video acquisition means for acquiring video;
a plurality of conversion means for converting an input feature map of the video and outputting a converted feature map, the plurality of conversion means being sequentially arranged;
an identification element extraction means for detecting an identification element from the video and outputting an identification element feature; and
an identification element reference conversion means for generating and outputting a converted feature map and a converted identification element feature based on an input feature map and the identification element feature, the identification element reference conversion means being arranged between the plurality of conversion means.

### (Supplementary Note 2)

The video processing device according to supplementary note 1, wherein the identification element reference conversion means includes:
a feature map acquisition means for acquiring the input feature map;
an identification element feature acquisition means for acquiring the identification element feature;
a generation means for generating a query, a key, and a value from each of the feature map and the identification element feature;
an attention weight generation means for generating an attention weight from the query and the key;
a weighted sum calculation means for calculating a response value, which is a weighted sum of the value, according to the attention weight;
a response value conversion means for converting the response value into a feature map residual and an identification element feature residual;
a first addition means for calculating the converted feature map as a sum of the feature map and the feature map residual; and
a second addition means for calculating the converted identification element feature as a sum of the identification element feature and the identification element feature residual.

### (Supplementary Note 3)

The video processing device according to supplementary note 2, wherein
the identification element reference conversion means further includes a plurality of attention means provided for each type of the identification element, and
each of the plurality of attention means converts the feature map residual and the identification element feature residual based on the individual identification element feature.

### (Supplementary Note 4)

The video processing device according to supplementary note 1, wherein the identification element extraction means outputs the identification element feature based on the video and a feature map output by a conversion layer located before the identification element reference conversion means.

### (Supplementary Note 5)

The video processing device according to supplementary note 1, wherein the plurality of conversion means and the identification element reference conversion means include a neural network.

### (Supplementary Note 6)

A video processing method to be executed by a computer, the method comprising:
acquiring video;
converting an input feature map of the video and outputting a converted feature map;
detecting an identification element from the video and outputting an identification element feature; and
generating and outputting a feature map and an identification element feature based on the converted feature map and the identification element feature.

### (Supplementary Note 7)

A recording medium recording a program for causing a computer to perform a process comprising:
acquiring video;
converting an input feature map of the video and outputting a converted feature map;
detecting an identification element from the video and outputting an identification element feature; and
generating and outputting a feature map and an identification element feature based on the converted feature map and the identification element feature.

While the present disclosure has been particularly shown and described with reference to example embodiments and examples thereof, the present disclosure is not limited to these example embodiments and examples. It will be understood by those of ordinary skill in the art that various changes in form and details may be made therein without departing from the spirit and scope of the present disclosure as defined by the claims.

### DESCRIPTION OF SYMBOLS

1 video processing device
5 prediction device
21 conversion layer
22 identification element extractor
23, 23a, 23b, 23c, 23d identification element reference non-local layer
31 video feature query generation unit
32 resolution conversion unit
33 video feature key generation unit
34 video feature value generation unit
35a, 35b, 35c concatenation unit
41 identification element query generation unit
43 identification element key generation unit
44 identification element value generation unit
45 attention weight generation unit
46 weighted sum calculation unit
47 response value conversion unit
48 first addition unit
49 second addition unit
100, 100x feature conversion device

What is claimed is:

1. A video processing device comprising:
a plurality of conversion layers that convert an input feature map of a video and output a converted feature map, the plurality of conversion layers being sequentially arranged;
at least one identification element extractor that detects an identification element from the video and outputs an identification element feature; and
at least one identification element reference conversion layer that generates and outputs a converted feature map and a converted identification element feature based on an input feature map and the identification element feature, the identification element reference conversion layer being arranged between the plurality of conversion layers.

2. The video processing device according to claim 1, wherein
the identification element reference conversion layer is configured to execute the processing to:
acquire the input feature map;
acquire the identification element feature;
generate a query, a key, and a value from each of the feature map and the identification element feature;
generate an attention weight from the query and the key;
calculate a response value, which is a weighted sum of the value, according to the attention weight;
convert the response value into a feature map residual and an identification element feature residual;
calculate the converted feature map as a sum of the feature map and the feature map residual; and
calculate the converted identification element feature as a sum of the identification element feature and the identification element feature residual.

3. The video processing device according to claim 2, wherein
the identification element reference conversion layer further includes a plurality of attention mechanisms provided for each type of the identification element, and
each of the plurality of attention mechanisms converts the feature map residual and the identification element feature residual based on the individual identification element feature.

4. The video processing device according to claim 1, wherein the identification element extractor outputs the identification element feature based on the video and a feature map output by the conversion layer located before the identification element reference conversion layer.

5. The video processing device according to claim 1, wherein the plurality of conversion layers and the identification element reference conversion layer are implemented using a neural network.

6. A video processing method to be executed by a computer, the method comprising:
converting an input feature map of a video and outputting a converted feature map;
detecting an identification element from the video and outputting an identification element feature; and
generating and outputting a feature map and an identification element feature based on the converted feature map and the identification element feature.

7. A recording medium recording a program for causing a computer to perform a process comprising:
converting an input feature map of a video and outputting a converted feature map;
detecting an identification element from the video and outputting an identification element feature; and
generating and outputting a feature map and an identification element feature based on the converted feature map and the identification element feature.
